(19) United States
(12) Patent Application Publication
(10) Pub. No.: US 2009/0252945 A1
(43) Pub. Date: Oct. 8, 2009

(54) Method and apparatus for the coating and for the surface treatment of substrates by means of a plasma beam

(76) Inventors: Arno Refke, Fahrwangen (CH); Christoph Hollenstein, Lutry (CH)

Correspondence Address: ROBERT S. GREEN, SULZER METCO (US), INC., 1101 PROSPECT AVENUE, WESTBURY, NY, 11590, US

(21) Appl. No.: 12/418,014

(22) Filed: Apr. 3, 2009

(30) Foreign Application Priority Data
Apr. 4, 2008 (EP) 08154091.6

(51) Int. Cl. B32B 7/02; B05D 1/10; B05B 7/22

(52) U.S. Cl. 428/220; 427/446; 118/620

(57) ABSTRACT

For the coating and for the surface treatment of substrates by means of a plasma beam a working chamber (2) with a plasma torch (4) is made available, a plasma beam (5) is produced in that a plasma gas is directed through the plasma torch (4) and is heated in the same by means of electrical gas discharge, electromagnetic induction or microwaves, and the plasma beam (5) is directed onto a substrate (3) introduced into the working chamber, wherein the plasma torch (4) which is made available has a power for the thermal plasma spraying of solid material particles. During the coating and/or the surface treatment, the pressure in the working chamber (2) amounts to between 0.01 and 10 mbar, and at least one reactive component in liquid or gaseous form is injected into the plasma beam (5) in order to coat the surface of a substrate (3) or to treat it.

The invention relates to a method for the coating and/or for the surface treatment of substrates by means of a plasma beam in accordance with the preamble of claim 1, to a substrate manufactured with such a method and to a plasma coating apparatus in accordance with the preamble of claim 11 for the carrying out of such a method.

Coating apparatuses, for example vacuum deposition plants, sputtering plants, plants for chemical vapour deposition and thermal spraying apparatuses such as for example thermal plasma spraying apparatuses are used nowadays in many areas of industrial manufacture in order to coat substrates. Typical substrates include, for example, workpieces with curved surfaces such as for example tools or cylinder running surfaces of internal combustion engines, a multitude of components and semi-finished products, to which, for example, a corrosion protection is applied by means of a thermal spraying process, but also essentially planar substrates such as wafers and foils on which a coating is applied, for example conductive or insulating layers for semiconductors, such as for example solar cells. The layers applied can, for example, be used to make the surface resistant to mechanical and/or chemical and in particular corrosive influences, to reduce the friction and/or the adhesion on the surface, to make the surface electrically and/or thermally insulating or, if required, conductive, to make the surface suitable for foodstuffs and/or compatible for blood or tissue and/or to form seals and diffusion barriers in order to name just a few typical applications.

Plants having a plasma source were developed for the reactive treatment of surfaces and for the reactive deposition of thin layers by means of a plasma. The corresponding methods are known under the term plasma surface treatment, plasma etching, plasma coating or plasma enhanced chemical vapour deposition (plasma enhanced CVD). A plant for such methods is described in the document EP 0 297 637 A1. The plant described there includes a chamber having a plasma torch of up to 1 kW power and an evacuatable treatment chamber which contains the substrate to be treated. The reactive treatment agent is supplied to a plasma torch in gaseous or liquid form. The pressure in the treatment chamber amounts during the treatment to less than 50 mbar. Using a plant of this kind thin layers of up to 1 or 2 μm thickness can be applied on substrates of up to 0.01 m² area. For larger substrates, or for the application of thicker layers, the plant described in EP 0 297 637 A1 is not suitable because the deposition rate for this is too low.

It is the object of the invention to make available a method and a coating apparatus for the coating and/or for the surface treatment of substrates by means of a plasma beam, with which reactively manufactured layers of for example 2 μm thickness or on comparatively large substrate areas of 0.05 m² or larger can be applied, as well as, if required, thicker layers of, for example, 50 μm thickness or more. A further object is to make available substrates or workpieces which were manufactured with such a method.

This object is satisfied in accordance with the invention by the method defined in claim 1, by the substrate or workpiece defined in claim 10 and by the plasma coating apparatus defined in claim 13.

In the method of the invention for the coating and for the surface treatment of the substrates by means of a plasma beam, a working chamber with a plasma torch is made available, a plasma beam is produced in that a plasma gas is directed through the plasma torch and is heated in the same by means of electrical gas discharge and/or electromagnetic induction and/or microwaves, and the plasma beam is directed onto a substrate introduced into the working chamber. The method is characterized in that the plasma torch which is made available has a power for the thermal plasma spraying of solid material particles, the pressure in the working chamber during the method amounts to between 0.01 and 10 mbar, at least one reactive component in liquid or gaseous form is injected into the plasma beam in order to coat the surface of a substrate and/or to treat it and a layer or coating is manufactured and/or a substrate surface is treated and the layer or coating manufactured in this manner or the substrate surface treated in this manner each have a thickness of 0.01 μm to 10 μm.

The plasma torch advantageously has a maximum power of 10 kW to 200 kW or 20 kW to 100 kW or the maximum power of the plasma torch amounts to at least 30 kW or at least 50 kW or at least 70 kW and/or lies between 20 kW and 150 kW. In practice a plasma torch for the thermal plasma spraying of solid material particles is thus normally used. Furthermore, the pressure in the working chamber during the process can, for example, amount to between 0.02 mbar and 5 mbar or to between 0.05 mbar and 2 mbar. If required the reactive component is injected in the plasma torch into the plasma beam and/or into the free plasma beam. In an advantageous variant coating material in the form of powder-like solid material particles or in the form of a suspension is additionally introduced into the plasma beam. In a further advantageous variant the layer or coating manufactured by means of the above-described method or the above-described variants or the substrate surface treated in this way have a porosity of 0.01% to 5% or 0.02% to 2%.

A coating having at least two layers of different structure can be applied by means of a special embodiment of the method, with at least one of the layers being manufactured using the above method, termed a thin layer process in the following, or being manufactured using one of the above variants and at least one further layer is applied by means of thermal plasma spraying of solid material particles, with both layers being applied with the same plasma torch.

The pressure in the working chamber during the thermal plasma spraying advantageously amounts to between 0.3 mbar to 1 bar or 0.5 mbar to 500 mbar or 1 mbar to 200 mbar. The at least one layer which is applied by means of thermal plasma spraying can for example have a thickness of 1 μm to 2000 μm or 10 μm to 1000 μm.

Furthermore, the invention includes a substrate or workpiece with at least one layer manufactured with the above-described thin layer process or with the above-described variants or with at least two layers of different structure manufactured with the above-described special embodiment of the method. In the latter case the substrate or workpiece can, for example, include at least one layer which is applied by means of the thermal plasma spraying of solid material particles and at least one layer manufactured with the above-described thin layer process, or with the above-described variants, as a cover layer. In an advantageous variant the layer applied by means of the thermal plasma spraying of solid material particles contains one or more oxide ceramic components or consists of one or more oxide ceramic components and/or the layer manufactured with the above-described thin layer process, or with the above-described variants, consists essentially of SiOₓ.

The plasma coating apparatus in accordance with the invention for the coating and/or for the surface treatment of substrates includes a working chamber having a plasma torch for the generation of a plasma beam, a controlled pump apparatus which is connected to the working chamber and a substrate holder for the holding of the substrate, with the plasma torch having a power for thermal plasma spraying of solid material particles, with the pressure in the working chamber being adjustable by means of the controlled pump apparatus to a value between 0.01 mbar and 1 bar, or to between 0.02 mbar und 0.2 bar and with the plasma coating apparatus additionally having an injection device in order to inject at least one reactive component in liquid or gaseous form into the plasma beam.

In an advantageous variant the plasma coating apparatus additionally includes a controlled setting device for the plasma torch in order to control the direction of the plasma beam and/or the spacing of the plasma torch from the substrate in the range of 0.2 m to 2 m or 0.3 m to 1 m. In a further advantageous variant, the plasma torch is made as a DC plasma torch.

The method and the plasma coating apparatus in accordance with the present invention have the advantage that comparatively large substrate areas of for example 0.05 m² or larger can be provided with reactively manufactured layers, for example with thin layers of 2 μm thickness or less, wherein the substrate surface, which is to be treated or coated, can be assembled from a plurality of smaller substrate surfaces. Additionally, it is also possible to treat and/or to coat longer foils or substrates of for example 2 m length and more in a quasi-continuous process, for example in a “roll to roll” process. With the method in accordance of the invention high quality thin layers can be manufactured which are, for example, comparatively homogenous with respect to thickness and/or composition and/or, for example, have a porosity of 0.01% to 5% or 0.02% to 2%. If required, thicker layers of for example 50 μm thickness or more can be manufactured by means of a thermal plasma spraying process for solid material particles. This has the advantage that coatings can be applied in the same plasma coating apparatus which contain both reactively manufactured thin layers and also thicker layers, with the layers being able to be applied directly one after the other.

The above description of embodiments and variants serves merely as an example. Further advantageous embodiments can be seen from the dependent claims and from the drawings. Moreover, in the context of the present invention, individual features from the described or illustrated embodiments and variants can also be combined with one another in order to form new embodiments.

In the following the invention will be explained in more detail with reference to embodiments and to the drawings in which are shown:

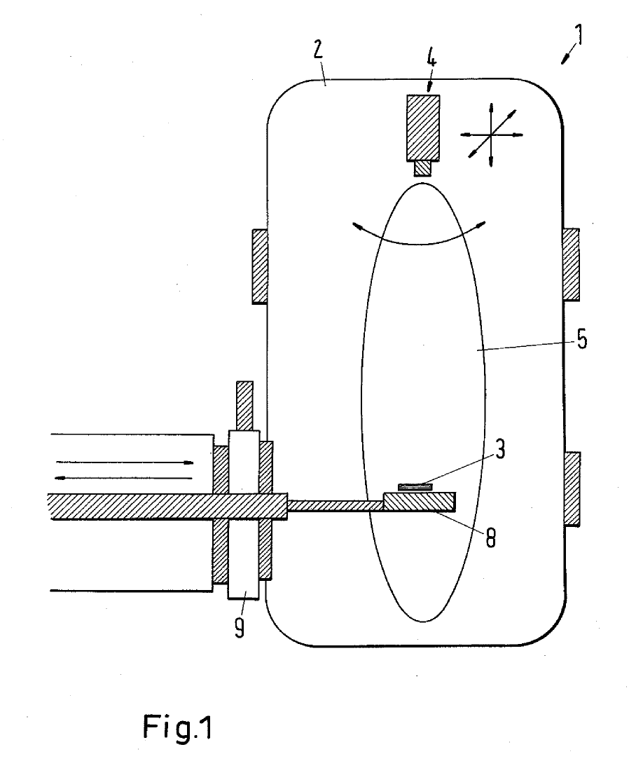

FIG. 1 an embodiment of a plasma coating apparatus in accordance with the present invention,

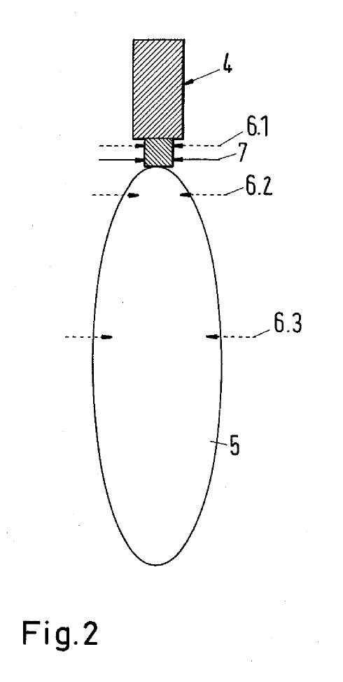

FIG. 2 variants for the injection of a reactive component in liquid or gaseous form into a plasma beam and

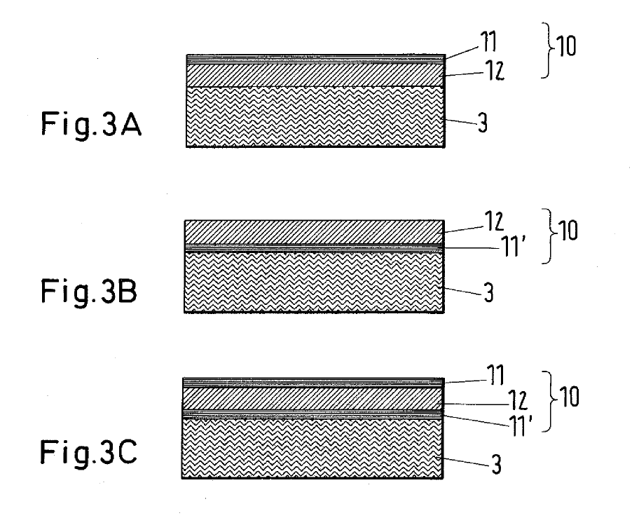

FIGS. 3A, B, C three embodiments of substrate coatings manufactured with a method in accordance with the present invention.

FIG. 1 shows an embodiment of a plasma coating apparatus for the coating and/or for the surface treatment of substrates in accordance with the present invention. The plasma coating apparatus 1 includes a working chamber 2 having a plasma torch 4 for the generation of a plasma beam 5, a controlled pump apparatus, which is not shown in FIG. 1, but which is connected to the working chamber 2 in order to set the pressure in the working chamber and a substrate holder 8 for the holding of the substrate 3, wherein the plasma torch 4 has a power for the thermal plasma spraying of solid material particles, wherein the pressure in the working chamber 2 can be set by means of the controlled pumping apparatus to a value between 0.01 mbar and 1 bar or to between 0.02 mbar and 0.2 bar and wherein the plasma coating apparatus 1 additionally has an injection device 6.1-6.3 in order to inject at least one reactive component in liquid or gaseous form into the plasma beam 5. The plasma torch 4 is advantageously made as a DC plasma torch.

If required, the substrate holder 8 can be executed as a displaceable bar holder in order to move the substrate out of a pre-chamber through a seal lock 9 into the working chamber 2. The bar holder additionally enables the substrate to be turned, if required, during the treatment and/or the coating process.

The plasma torch advantageously has a maximum power of 10 kW to 100 kW, in particular 20 kW to 100 kW or the maximum power amounts to at least 30 kW or at least 50 kW or at least 70 kW. In practice, a plasma torch for the thermal plasma spraying of solid material particles is thus normally used. The plasma torch is typically connected to a power supply, for example to a DC supply for a DC plasma torch and/or to a cooling apparatus and/or to a plasma gas supply and is, if required, provided with a supply for liquid and/or gaseous reactive components and/or a conveying apparatus for spray powder or suspension.

A customary plasma torch having a power for thermal spraying, for example a customary plasma torch for thermal spraying can for example include an anode and a cathode in order to generate an electric discharge, with the anode and cathode normally being cooled in the power range necessary for thermal spraying, for example by means of coolant water. A process gas supply to the plasma torch, also termed a plasma gas, is ionized in the electrical discharge in order to produce a plasma beam having a temperature of up to 20,000 K. As a result of thermal expansion of the gases, i.e. of the plasma, the plasma beam leaves the plasma torch with a speed of typically 200 m/s to 4000 m/s. The process gas or plasma gas can for example be argon, nitrogen, helium and/or hydrogen or a mixture of a noble gas with nitrogen and/or hydrogen, i.e. can consist of one or more of these gases.

FIG. 2 shows three variants for the injection of a reactive component in liquid or gaseous form into a plasma beam 5. The plasma beam 5 is, as shown in FIG. 2, produced in a plasma torch 4. Depending on the variant an injector 6.1 is provided in the plasma torch in order to inject a reactive component into the plasma beam. The injector 6.1 can for example be arranged in the region of a nozzle which is provided for the forming of the plasma beam in the plasma torch. The reactive component can however also be injected by means of an injector 6.2, 6.3 into the free plasma beam, for example by means of an injector 6.2 which is arranged at a spacing of a few cm from the nozzle outlet opening of the plasma torch or by means of an injector 6.3 which is arranged at a distance of 0.1 m to 0.6 m from the plasma torch. As long as the plasma beam is still only fanned out to a small degree, the injector is advantageously arranged substantially centrally on the plasma beam. If the plasma beam is more strongly fanned out, for example at a distance of typically more than 0.1 m from the plasma torch, then ring-like injectors can for example also be used.

In a further advantageous variant the plasma coating apparatus 1 additionally includes a controlled setting device for the plasma torch 4, which is not shown in FIG. 1, in order to control the direction of the plasma beam and/or the spacing of the plasma torch from the substrate 3, for example in a range of 0.2 m to 2 m or 0.3 m to 1 m. If required one or more pivot axes in different directions can be provided in the setting device. Moreover, the setting device can also include one or two additional linear adjustment axes in order to arrange the plasma torch 4 over different regions of the substrate 3. Linear movements and pivotal movements of the plasma torch permit a control of the substrate treatment and substrate coating, for example in order to uniformly preheat a substrate over the entire surface or in order to achieve a uniform layer thickness and/or layer quality on the substrate surface.

In an advantageous embodiment the plasma torch 4 is provided with one or more feeds 7 in order to feed coating material in the form of powder-like solid material particles and/or in the form of a suspension and to apply layers by means of thermal plasma spraying. The feed or feeds 7 can for example be directed up to and into the region of a nozzle which is provided for the forming of the plasma beam in the plasma torch in order to introduce powder-like solid material particles and/or suspensions into the plasma beam 5 at this point. The powder-like solid material particles are normally supplied by means of a conveying gas.

An embodiment of the method of the invention for the coating and/or for the surface treatment of substrates by means of a plasma beam will be described in the following with reference to the FIGS. 1, 2 and 3A-C. In the method a working chamber 2 is made available with a plasma torch 4, a plasma beam 5 is generated in that a plasma gas is directed through the plasma torch and is heated in the latter by means of electrical gas discharge and/or electromagnetic induction and/or microwaves and the plasma beam 5 is directed onto a substrate 3 introduced into the working chamber 2. The method is characterized in that the plasma torch 4 which is made available has a power for the thermal plasma spraying of solid material particles, in that the pressure in the working chamber 2 during the method amounts to 0.01 and 10 mbar, in that at least one reactive component in liquid or gaseous form is injected into the plasma beam 5 in order to coat and/or to treat a surface of the substrate and in that a layer 11, 11′ or coating 10 is manufactured and/or a substrate surface is treated and the layer or coating manufactured in this manner or the substrate surface treated in this manner each have a thickness of 0.01 μm to 10 μm.

Possible treatments of the surface of the substrate 3 include for example the heating up, cleaning, etching, oxidizing or nitriding by means of a plasma beam. Some embodiments of coatings which were produced using the above-described method will be explained in more detail in the following in the context of the description of the FIGS. 3A-C.

The plasma torch 4 advantageously has a maximum power of 10 kW to 200 kW, in particular of 20 kW to 150 kW or 20 kW to 100 kW or the maximum power amounts to at least 30 kW or at least 50 kW or at least 70 kW. Furthermore, the pressure in the working chamber 2 during the method can for example amount to between 0.02 mbar and 5 mbar or to between 0.05 mbar and 2 mbar. If required the reactive component is injected in the plasma torch into the plasma beam and/or into the free plasma beam. FIG. 2 shows three variants for the injection of the reactive component in liquid or gaseous form into the plasma beam 5. The three variants were explained already in more detail in the context of the above description of the plasma coating apparatus.

If required the plasma beam 5 can be swung over the surface of the substrate during the treatment or the coating in order to achieve a uniform treatment or coating and in order to avoid possible local heating up and/or damage to the substrate surface or to the substrate which could arise with a constantly directed plasma beam at high beam power.

In an advantageous variant coating material in the form of powder-like solid material particles or in the form of a suspension is additionally introduced into the plasma beam 5. In a further advantageous variant the layer 11, 111′ or coating 10 manufactured using the above-described method or the above-described variants or the so treated substrate surface have a porosity of 0.01% to 5% or 0.02% to 2%.

Coatings having at least two layers of different structure can be applied by means of a special embodiment of the method, with at least one of the layers being manufactured using the above method, termed the thin layer method in the following, or being manufactured using the above variants and at least one further layer being applied by means of thermal plasma spraying of solid material particles, with both layers being applied with the same plasma torch 4.

The pressure in the working chamber 2 advantageously amounts during thermal plasma spraying to between 0.3 mbar to 1 bar or to 0.5 mbar to 500 mbar or to 1 mbar to 200 mbar. The at least one layer which is applied by means of thermal plasma spraying can for example have a thickness of 1 μm to 2000 μm or 10 μm to 1000 μm.

Furthermore, the invention includes a substrate 3 or workpiece manufactured with at least one layer with the above-described thin layer process or with the above-described variants or manufactured with at least two layers at a different structure with the above-described special embodiment of the method. In the latter case this substrate or workpiece can include, for example, at least one layer which was applied by means of thermal plasma spraying of solid material particles and at least one layer manufactured with the above-described thin layer process or with the above-described variants as a cover layer. In an advantageous variant the layer applied by means of the thermal plasma spraying of solid material particles can include one or more oxide ceramic components such for example Al₂O₃, TiO₂, Cr₂O₃, ZrO₂, Y₂O₃ or Al—Mg-Spinell or consist of one or more oxide ceramic components and/or the layer manufactured with the above-described thin layer process or with the above-described variants consists essentially of SiOₓ.

Typical applications of substrates with at least two layers of different structure which were manufactured with the above-described special embodiment of the method include for example:
a layer of Al₂O₃ or Al—Mg-Spinell applied by means of thermal plasma spraying of solid material particles as an electrical insulating layer and/or thermal insulating layer and a cover layer of SiOₓ as a seal applied with the above-described thin layer process,
a layer of TiO₂, Al₂O₃/TiO₂ or Cr₂O₃ applied by means of plasma spraying of solid material particles as an optical absorption layer, for example to improve the efficiency of solar thermal components and a cover layer of SiOₓ applied with the above-described thin layer process as a protection against back reflection, or
a layer of ZrO₂ and/or Y₂O₃ applied by means of thermal plasma spraying of solid material particles for electronic applications and/or as a thermal insulating layer and a cover layer of ZrO₂ or SiOₓ applied as a seal with the above-described thin layer process.

The FIGS. 3A-C show three embodiments of substrate coatings 10 which were manufactured using the above-described special embodiment of the method. In the embodiment shown in FIG. 3A a substrate 3 is first provided by means of thermal plasma spraying with a layer 12 of typically 2 μm to 1000 μm thickness and subsequently a 0.1 μm to 1 μm thick cover layer 11 was applied by means of a reactive thermal low pressure plasma. In the embodiment shown in FIG. 3B a substrate 3 was first provided by means of a reactive thermal low pressure plasma with a layer 11′ of typically 0.1 μm to 1 μm thickness which for example can be formed as a bond layer or diffusion barrier layer and a layer 12 of for example typically 2 μm to 1000 μm thickness was subsequently applied by means of thermal plasma spraying. In the third embodiment which is shown in FIG. 3C a substrate 3 was provided by means of a reactive thermal low pressure plasma with a first layer 11′ of typically 0.1 μm to 1 μm thickness and by means of a thermal plasma spraying process with a second layer 12 of typically 2 μm to 1000 μm thickness and subsequently a 0.1 μm to 1 μm thick cover layer 11 was applied by means of a reactive thermal low pressure plasma.

In the following embodiment of the method of the invention the manufacture and use of a thin SiOₓ layer by means of a reactive thermal low pressure plasma will be explained in more detail. For the manufacture a commercially usual plasma torch with a power for thermal plasma spraying can be used, for example a plasma torch having three cathodes and cascaded anode, the torch being equipped with water cooling. A mixture of argon and hydrogen or argon and helium can be used as the plasma gas and the reactive component which is injected into the plasma beam can for example consist of a mixture of gaseous hexamethyldisiloxane (HMDSO) with oxygen. The proportion of oxygen in the HMDSO/O₂ mixture typically amounts to around 2% to 3% related to the gas flow. In order to achieve a high gas yield the reactive component is normally injected into the plasma beam at a comparatively small distance from the substrate surface, for example by means of a ring-like injector which is arranged at a distance of a few cm from the substrate surface. The distance of the plasma torch from the substrate can for example amount to 0.3 m to 0.6 m, the pressure in the working chamber can for example be 0.2 mbar to 1 mbar and the power supplied to the plasma torch can for example be 8 kW to 16 kW.

In this manner high quality SiOₓ layers of up to 2 μm thickness can be applied. The deposition rate on a substrate of 30 cm×30 cm is typically 10 nm/s or higher, with a high gas yield being able to be achieved related to the HMDSO gas that is supplied. SiOₓ layers of typically 0.1 μm thickness or less are for example used in the packaging industry as a diffusion barrier layer against water vapour and oxygen. Moreover, applications for such layers exist in the textile industry.

In a further embodiment of the method of the invention the manufacture of an electrical insulating coating will be explained in more detail. The layout of the coating corresponds to that in the embodiment shown in FIG. 3A, i.e. a substrate 3 to be coated is first provided by means of thermal plasma spraying with an Al₂O₃ layer 12 with typically 20μ to 40 μm thickness and subsequently a 0.1 μm to 0.2 μm thick cover layer 11 of SiOₓ is applied by means of a reactive thermal low pressure plasma. If required the substrate surface is cleaned prior to the coating in order to increase the bond of the coating. In the present embodiment the surface to be coated is for example first cleaned with alcohol and subsequently sand-blasted with fine powder.

A commercially customary plasma torch for thermal plasma spraying can for example be used for the manufacture of the coating 10. In this example a mixture of argon with 4% to 10% hydrogen is used as the plasma gas. For the thermal plasma spraying of the first layer 12 the spacing of the plasma torch 4 from the substrate 3 can, for example, amount to from 0.8 m to 1.2 m and the pressure in the working chamber can, for example, amount to 0.5 mbar to 2 mbar. This results in a comparatively broad plasma beam with which larger substrates of 0.05 m² and larger can also be coated. The power supply to the plasma torch for the thermal plasma spraying typically amounts to 60 kW to 100 kW, with the plasma torch being water-cooled so that a part of the power is given up to the coolant water.

Prior to the coating the substrate 3 is normally preheated in order to improve the bond of the first layer 12 on the substrate. The preheating of the substrate can take place with the same plasma parameters as the application of the first layer, with it normally being sufficient to move the plasma beam 5, which contains neither coating powder nor reactive components for the preheating, with a few swinging movements over the substrate. Typically 20 to 30 swinging movements are sufficient to heat the substrate surface to a temperature of 200° C. to 500° C.

Depending on the type and quantity of the coating powder to be melted this can be supplied by one or more feeds in the plasma torch 4 where the enthalpy is larger or the coating powder can be injected outside of the same into the plasma beam 5. In the present embodiment the Al₂O₃ powder is for example fed via two oppositely disposed feeds relative to the plasma beam in the plasma torch. Argon can for example be used as the feed gas for the Al₂O₃ powder. After the preheating of the substrate surface the application of the first layer is started, with the plasma beam 5, which contains the melted coated powder, being guided by means of swinging movements over the substrate 3. If required the substrate can additionally be moved by means of the bar holder 8 or can be moved in placed of pivoting of the plasma beam. A 20 μm to 40 μm thick Al₂O₃ layer can be applied within 2 to 5 min with about 100 to 200 swinging movements of the plasma beam.

In a further step, as described in the context of the preceding embodiments, a 0.1 μm to 0.2 μm thick SiOₓ layer 11 is applied by means of a reactive thermal low pressure plasma. For this the plasma parameters are adapted in accordance with the preceding embodiment and a mixture of gaseous hexamethyldisiloxane (HMDSO) with oxygen is injected at a comparatively small distance from the substrate surface into the plasma beam 5. The supply for the coating powder remains interrupted during application of the SiOₓ layer. After the application of the SiOₓ layer the isolating coating 10 is complete.

If the substrate 3 is secured to a bar holder 8 then it can withdrawn from the working chamber into a pre-chamber for the cooling down. The pre-chamber is expediently filled with argon, with the cooling down time and the pressure in the pre-chamber being able to be adapted to the type of substrate and the type of coating. A cooling down time of 10 min at a pressure of 0.5 bar in argon is normally sufficient in order to avoid internal stresses and cracks during the cooling down.

Electrical isolation layers such as for example Al₂O₃ layers which are applied by means of thermal spraying are never completely sealed and isolating as a result of the coating process that is used. The above-described coating with an Al₂O₃ layer applied by means of a thermal plasma spraying method and an SiOₓ cover layer produced by means of a reactive thermal low pressure plasma has the advantage that the take-up of water is reduced thanks to the cover layer and that substantially better isolation properties can be achieved.

The above-described plasma coating apparatus and the above-described method and also the associated variants permit a reactive manufacture of high quality thin layers on comparatively large substrate surfaces of for example 0.05 m² or larger and also if required the manufacture of thicker layers of for example 50 μm thickness or more and thus enable the industrial use of such layers.

1. A method for the coating and/or for the surface treatment of substrates by means of a plasma beam wherein
a working chamber (2) with a plasma torch (4) is made available,
a plasma beam (5) is produced in that a plasma gas is directed through the plasma torch (4) and is heated in the same by means of electrical gas discharge and/or electromagnetic induction and/or microwaves, and
the plasma beam (5) is directed onto a substrate (3) introduced into the working chamber,
characterized in that
the plasma torch (4) which is made available has a power for the thermal plasma spraying of solid material particles,
the pressure in the working chamber (2) during the method amounts to between 0.01 and 10 mbar,
at least one reactive component in liquid or gaseous form is injected into the plasma beam (5) in order to coat the surface of the substrate (3) and/or to treat it; and
a layer (11, 11′) or coating (10) is manufactured and/or a substrate surface is treated and the layer ir coating manufactured in this manner or the surface treated in this manner each have a thickness of 0.01 μm to 10 μm.

2. A method in accordance with claim 1, wherein the plasma torch (4) has a maximum power which amounts to at least 30 kW or at least 50 kW or at least 70 kW and/or lies between 20 kW and 150 kW.

3. A method in accordance with claim 1, wherein the pressure in the working chamber (2) during the method amounts to between 0.02 mbar and 5 mbar, in particular to between 0.05 mbar and 2 mbar.

4. A method in accordance with claim 1, wherein the reactive component is injected in the plasma torch into the plasma beam and/or wherein the reactive component is injected into the free plasma beam (5).

5. A method in accordance with claim 1, wherein additional coating material in the form of powder-like solid material particles or in the form of a suspension is introduced into the plasma beam (5).

6. A method in accordance with claim 1, wherein the so manufactured layer (11, 11′) or coating (10) or the so treated substrate surface has a porosity of 0.01% to 5%, in particular of 0.02% to 2%.

7. A method for the manufacture of coatings (10) having at least two layers (11, 11′, 12) of different structure, characterized in that at least one of the layers (11, 11′) is manufactured using a method in accordance with any one of the preceding claims and in that at least one further layer (12) is applied by means of thermal plasma spraying of solid material particles, with both layers being applied with the same plasma torch (4).

8. A method in accordance with claim 7, wherein the pressure in the working chamber (2) during the thermal plasma spraying amounts to between 0.3 mbar to 1 bar, in particular to between 0.5 mbar to 500 mbar or 1 mbar to 200 mbar.

9. A method in accordance with claim 7, wherein the at least one layer (12) which is applied by means of thermal plasma spraying has a thickness of 2 μm to 2000 μm, in particular of 10 μm to 1000 μm.

10. A substrate or workpiece having at least one layer (11, 11′) manufactured in accordance with a method in accordance with claim 1.

11. A substrate or workpiece in accordance with claim 10, having at least two layers (11, 11′, 12) of different structure including at least one layer (12) which was applied by means of thermal plasma spraying of solid material particles and at least one layer (11) manufactured in accordance with a method in accordance with claim 1 as a cover layer.

12. A substrate or workpiece in accordance with claim 11, wherein the layer (12) applied by means of thermal plasma spraying of solid material particles contains one or more oxide ceramic components or consists of one or more oxide ceramic components and wherein the layer (11) consists essentially of SiOₓ.

13. A plasma coating apparatus for the coating and/or surface treatment of substrates comprising a working chamber (2) having a plasma torch (4) for the generation of a plasma beam (5), a controlled pump apparatus which is connected to the working chamber and a substrate holder (8) for the holding of the substrate (3), characterized in that the plasma torch (4) has a power for the thermal plasma spraying of solid material particles, in that the pressure in the working chamber (2) is adjustable by means of the controlled pump apparatus to a value between 0.01 mbar and 1 bar, in particular to between 0.02 mbar und 0.2 bar and in that the plasma coating apparatus (1) additionally has an injection device (6.1-6.3) in order to inject at least one reactive component in the liquid or gaseous form into the plasma beam (5).

14. A plasma coating apparatus in accordance with claim 13 additionally including a controlled setting device for the plasma torch (4) in order to control the direction of the plasma beam (5) and/or the spacing of the plasma torch (4) from the substrate in a range from 0.2 m to 2 m, in particular in a range from 0.3 m to 1 m.

15. A plasma coating apparatus in accordance with claim 13, wherein the plasma torch (4) is made as a DC plasma torch.

16. A substrate or workpiece having at least two layers (11, 11′, 12) of a different structured manufactured in accordance with a method in accordance with claim 7.
